(19) United States
(12) Patent Application Publication
(10) Pub. No.: US 2016/0056861 A1
(43) Pub. Date: Feb. 25, 2016

(54) COMMUNICATION TERMINAL AND COMMUNICATION SYSTEM

(71) Applicant: PANASONIC INTELLECTUAL PROPERTY MANAGEMENT CO., LTD., Osaka (JP)

(72) Inventors: Kazuhiko GOSHONOO, Mie (JP); Takashi ITO, Osaka (JP)

(21) Appl. No.: 14/781,573

(22) PCT Filed: Mar. 28, 2014
(86) PCT No.: PCT/JP2014/001836

§ 371 Date: Sep. 30, 2015

(30) Foreign Application Priority Data
Apr. 12, 2013 (JP) 2013-083760

(51) Int. Cl. H04B 3/56

(52) U.S. Cl. CPC H04B 3/56

(57) ABSTRACT

In a communication terminal, a power receiving circuit is connected to a transmission cable having two wires through junctions, and configured to receive electric power supplied from the transmission cable. A transmission circuit is connected between the junctions, and configured to transmit a current-mode signal on the transmission cable by short-circuiting therebetween. An intermediate circuit includes a series circuit of an inductor and a capacitor, and is connected in parallel with the transmission circuit between the junctions and also exists between the junctions and the power receiving circuit. The power receiving circuit is connected between both ends of the capacitor.

### TECHNICAL FIELD

The invention relates to a communication terminal and a communication system that are configured to transmit a current-mode signal on a transmission cable.

### BACKGROUND ART

Conventionally, there is known a system that includes a transmission unit and communication terminals (input and control terminals) that are connected to a signal cable and configured to perform data transmission by a time division multiplexing signal between the transmission unit and each communication terminal (for example, JP Pub. No. 2005-73075 (hereinafter referred to as “Document 1”)).

In the system described in Document 1, the transmission unit is configured to transmit a (multiplex) transmission signal on the signal cable (hereinafter referred to as a “transmission cable”). Each communication terminal is configured, when address data contained in the transmission signal agrees with its own address data which has been set, to return a current-mode signal by short-circuiting the transmission cable through suitably low impedance in synchronization with a return period of a transmission signal.

In this sort of system, it is known that each communication terminal secures a power supply for operation of its own internal circuit from a transmission signal on a transmission cable, namely is activated by electric power supplied from the transmission cable. There is however a possibility of deterioration in communication quality when power consumption of each communication terminal is comparatively large such as a communication terminal equipped with, for example, a liquid crystal display because the impedance to the transmission signal is decreased with comparatively large electric power supplied from the transmission cable.

Increasing the impedance through an impedance improving circuit can therefore be considered such as, for example, JP Pub. No. 2004-356771 (hereinafter referred to as “Document 2”). In Document 2, a load device with low input impedance in particular is connected to active and neutral lines, as a communication path of a power line carrier communication, through the impedance improving circuit.

However, there is still a possibility of deterioration in communication quality when a communication terminal(s) is connected to the transmission cable through an impedance improving circuit as described in Document 2 because the communication terminal itself transmits a current-mode signal and accordingly its own transmission signal is attenuated owing to the impedance improving circuit.

### SUMMARY OF INVENTION

The present invention has been achieved in view of the above circumstances, and an object thereof is to provide a communication terminal and a communication system, capable of suppressing deterioration in communication quality while receiving comparatively large electric power supplied from a transmission cable.

A communication terminal (2) of the invention comprises first and second junctions (P1, P2), a power receiving circuit (21), a transmission circuit (22) and an intermediate circuit (23). The power receiving circuit (21) is connected to a transmission cable (3) having two wires through the first and second junctions (P1, P2) and configured to receive electric power supplied from the transmission cable (3). The transmission circuit (22) is connected between the first and second junctions (P1, P2) and configured to transmit a current-mode signal on the transmission cable (3) by short-circuiting between the first and second junctions. The intermediate circuit (23) includes a series circuit of an inductor (L1) and a capacitor (C1), and is connected in parallel with the transmission circuit (22) between the first and second junctions (P1, P2), and also exists between the first and second junctions (P1, P2) and the power receiving circuit (21). The power receiving circuit (21) is connected between both ends of the capacitor (C1).

In an embodiment, the communication terminal (2) further comprises first and second input terminals (T1, T2) to be connected to the transmission cable (3), and a diode bridge (24). The diode bridge (24) exists between the first and second input terminals (T1, T2) and the first and second junctions (P1, P2).

In an embodiment, the intermediate circuit (23) further comprises a diode which exists between the inductor (L1) and the capacitor (C1) so as to prevent a discharging current from the capacitor (C1) from flowing through the inductor (L1).

In an embodiment, the inductor (L1) comprises a plurality of coils (L11, L12) in series.

In an embodiment, the intermediate circuit (23) further comprises a voltage limiting device (ZD1) which is connected in parallel with the capacitor (C1) so as to limit a voltage applied across the capacitor (C1).

In an embodiment, the intermediate circuit (23) further comprises a resistor (R1) which exists between the inductor (L1) and the capacitor (C1).

A communication system of the invention comprises the communication terminal (2), and a transmission unit (1) configured to be connected to the transmission cable (3).

The invention comprises the intermediate circuit which includes the series circuit of the inductor and the capacitor, and is connected in parallel with the transmission circuit between the first and second junctions. The power receiving circuit is connected between both ends of the capacitor. It is therefore possible to suppress deterioration in communication quality while receiving comparatively large electric power supplied from the transmission cable.

### BRIEF DESCRIPTION OF DRAWINGS

Preferred embodiments of the invention will now be described in further details. Other features and advantages of the present invention will become better understood with regard to the following detailed description and accompanying drawings where:

FIG. 1 is a schematic circuit diagram of a communication terminal in accordance with Embodiment 1;

FIG. 2 is a schematic block diagram of a communication system with communication terminals in accordance with Embodiment 1; and

FIG. 3 is a schematic circuit diagram showing a concrete example of a communication terminal in accordance with Embodiment 1.

### DESCRIPTION OF EMBODIMENTS

FIG. 2 illustrates a communication system. The communication system includes a transmission unit 1 and a plurality of communication terminals 201, 202, 203, . . . , to be connected to a transmission cable 3 having two wires. These communication terminals are hereinafter referred simply to as “communication terminals 2” when they are not distinguished. Each of the communication terminals 2 is configured to communicate with the transmission unit 1 by a transmission signal to be transmitted on the transmission cable 3 in accordance with a time division multiplexing protocol. That is, the communication system is a time sharing multiplex transmission system configured to perform data transmission on a time-division basis.

The communication system shown in FIG. 2 is employed as a control system configured to control apparatuses such as lighting fixtures, air conditioners and so forth in an office building or the like, for example. In this instance, the communication terminals 2 are classified into two categories—as either a monitor terminal configured to monitor an input of a switch such as a wall switch as a monitor input or a control terminal that includes a relay(s) and is configured to perform ON and OFF control of a corresponding apparatus(es).

The transmission unit 1 is configured to repeatedly transmit a transmission signal on the transmission cable 3 to communicate with the communication terminals 2 by transmission signals. The communication terminals 2 are connected in parallel to the transmission unit 1 through the transmission cable 3, and configured to not directly communicate with a corresponding one(s) but communicate with the corresponding one(s) through the transmission unit 1. Each communication terminal 2 is configured to secure a power supply for operation of its own internal circuit from a transmission signal on the transmission cable 3. That is, each communication terminal 2 is to be activated by receiving electric power supplied from the transmission cable 3.

The transmission signal is a bipolar (±24V) time division multiplexing signal with seven time periods containing a reserve interruption channel, a reserve channel, a transmission channel, a return channel, an interruption channel, a short circuit detection channel and an idle channel. The transmission channel is a time period in which the transmission unit 1 is allowed to transmit data to a communication terminal 2. The return channel is a time slot in which the transmission unit 1 is allowed to receive return data from a communication terminal 2.

The transmission unit 1 carries out regular polling by regularly transmitting transmission signals each of which contains mode data of ordinary mode and by cyclically changing address data contained in each transmission channel of the transmission signals, thereby sequentially accessing the communication terminals 2.

Each communication terminal 2 is, when address data contained in the transmission channel of a received transmission signal agrees with its own address, to receive control data contained in the transmission channel to transmit return data to the transmission unit 1 in a first return channel (in the same frame) after the transmission channel. At this time, the communication terminal 2 transmits the return data by a current-mode signal synchronized with the return channel of the transmission signal (a signal transmitted by short-circuiting the transmission cable 3 through suitably low impedance).

When receiving a monitor input from a monitor communication terminal 2, the transmission unit 1 transmits control data corresponding to the monitor input to a control communication terminal 2 corresponding to the monitor communication terminal 2 in accordance with a control table, stored therein, in which monitor communication terminals 2 are associated with control communication terminals 2 according to their addresses. The communication system can accordingly control the apparatuses in accordance with monitor inputs.

For example, the communication terminals 2 used for this sort of communication system include communication terminals 2, power consumption of each of which is comparatively large such as a communication terminal 2 equipped with, for example, a liquid crystal display. Each of such communication terminals 2 may have deterioration in communication quality because it receives comparatively large electric power supplied from the transmission cable 3, so that impedance to a transmission signal may be decreased. It is considered that communication terminals 2 with comparatively large power consumption be configured to receive electric power supplied from another power supply cable different from the transmission cable 3. In this instance, the power supply cable needs however to be installed in addition to the transmission cable 3.

### EMBODIMENT 1

The embodiment provides communication terminals 2 capable of suppressing deterioration in communication quality by suppressing a decrease in impedance to a transmission signal even while receiving comparatively large electric power supplied from a transmission cable 3. In the embodiment, it is therefore unnecessary to further install a power supply cable in addition to the transmission cable 3 because the communication terminals 2 are to receive electric power supplied from the transmission cable 3.

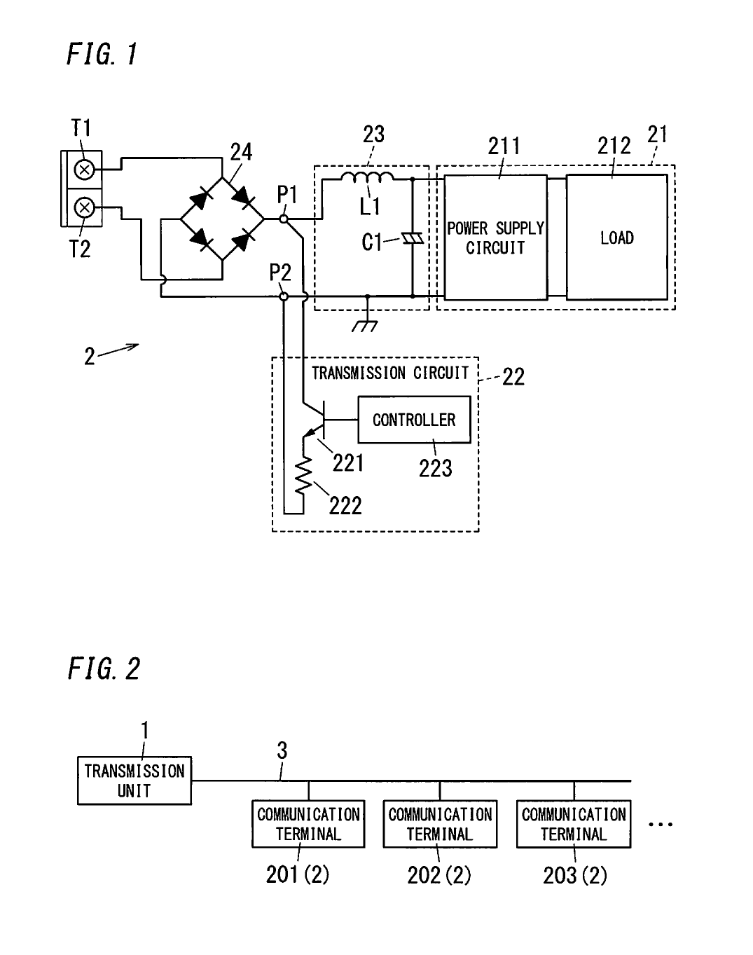

Each communication terminal 2 according to the embodiment is a terminal configured to be connected to the transmission cable 3, and includes first and second junctions P1 and P2, a power receiving circuit 21, a transmission circuit 22 and an intermediate circuit 23, as shown in FIG. 1. The power receiving circuit 21 is connected to the transmission cable 3 having two wires through the first and second junctions P1 and P2, and configured to receive electric power supplied from the transmission cable 3. In an example of FIG. 1, the power receiving circuit 21 includes a load 212, and is therefore configured to receive electric power supplied from the transmission cable 3 to consume the electric power. The transmission circuit 22 is connected between the first and second junctions P1 and P2, and configured to transmit a current-mode signal on the transmission cable 3. In the example of FIG. 1, the transmission circuit 22 is connected to the first and second junctions P1 and P2 which a direct-current voltage is applied across when electricity is supplied from the transmission cable 3. The transmission circuit is configured to transmit a current-mode signal on the transmission cable 3 by short-circuiting between the first and second junctions P1 and P2. The intermediate circuit 23 includes a series circuit of an inductor L1 and a capacitor C1, and is connected in parallel with the transmission circuit 22 between the first and second junctions P1 and P2. The intermediate circuit also exists between the first and second junctions P1 and P2 and the power receiving circuit 21. In the example of FIG. 1, the intermediate circuit 23 is an LC series circuit. The power receiving circuit 21 is connected between both ends of the capacitor C1.

In the embodiment, the power receiving circuit 21 includes a power supply circuit 211 configured to generate a power supply for operation of an internal circuit (including the transmission circuit 22 as well) of the communication terminal 2, and a load 212 configured to receive electric power supplied from the power supply circuit 211. That is, each communication terminal 2 secures a power supply for operation of its own internal circuit from a transmission signal on the transmission cable 3 as stated above, and electric power supplied from the transmission cable 3 is therefore consumed by the power receiving circuit 21. Each power supply circuit 211 of the power receiving circuits 21, for which a general-purpose DC/DC converter is used in the embodiment, may be a switching regulator or a linear regulator. The loads 212 may include loads, power consumption of each of which is comparatively large such as, for example, a liquid crystal display (not shown).

In the embodiment, each communication terminal 2 further includes first and second input terminals T1 and T2 to be connected to the transmission cable 3, and a diode bridge 24. The diode bridge 24 exists between the first and second input terminals T1 and T2 and the first and second junctions P1 and P2. The diode bridge 24 functions as a non-polarizing circuit, and each communication terminal 2 has no polarization with respect to the transmission cable 3. That is, a direct-current voltage with constant polarity is applied across the first and second junctions P1 and P2 regardless of connection polarity of the first and second input terminals T1 and T2 to the transmission cable 3. In the embodiment, the first and second junctions P1 and P2 are connected to the diode bridge 24 so that the first junction P1 and the second junction P2 correspond to high potential and low potential (circuit ground), respectively. That is, the first and second junctions P1 and P2 are connected to positive and negative output terminals of the diode bridge 24, respectively.

The transmission circuit 22 is configured to transmit a current-mode signal by short-circuiting the transmission cable 3 through low impedance. Specifically, as shown in FIG. 1, the transmission circuit 22 has a switching device and a low impedance device that are connected in series between the first and second junctions P1 and P2, and a controller 223. For example, the switching device is a transistor 221 and the low impedance device is a (first) resistor 222 having suitably low impedance. The controller 223 is configured to control the transistor 221. A collector of the transistor 221 as a first end of the switching device is connected to the first junction P1 on a side of the high potential, while an emitter of the transistor 221 as a second end of the switching device is connected to the second junction P2 (the circuit ground) on a side of the low potential through the resistor 222. A base of the transistor 221 as a control end of the switching device is connected to the controller 223. The transistor 221 forms a variable impedance device configured to change impedance between the first and second junctions P1 and P2 to high impedance when it is turned off, and to change the impedance between the first and second junctions P1 and P2 to low impedance when it is turned on.

In this configuration, the transmission circuit 22 short-circuits the transmission cable 3 through suitably low impedance when the transistor 221 is turned on. Therefore, the controller 223 turns on and off the transistor 221 according to a voluntary pattern, and the transmission circuit 22 can accordingly transmit a current-mode signal according to the voluntary pattern. The signal corresponds to a return signal containing the aforementioned return data.

As shown in FIG. 1, the intermediate circuit 23 includes the series circuit of the inductor L1 and the capacitor C1, and the series circuit is connected in parallel with the transmission circuit 22 between the first and second junctions P1 and P2. In the embodiment, the inductor L1 is connected to the first junction P1 on the side of the high potential, and the capacitor C1 is connected to the first junction P1 through the inductor L1. In other words, the intermediate circuit 23 has the inductor L1 and the capacitor C1 that are connected to the transmission cable 3 through the diode bridge 24.

The inductor L1 has a circuit constant that is set so as to increase impedance, between the first and second junctions P1 and P2, with respect to the transmission signal and the return signal. That is, the inductor L1 functions as an impedance-upper configured to raise (increase) impedance of the communication terminal 2 seen from the transmission cable 3. Moreover, the inductor L1 is connected to a secondary side of the diode bridge 24. The intermediate circuit 23 can suppress a decrease in impedance caused by a reverse voltage (counter electromotive force) occurring in the inductor L1 because the direction of the voltage applied across the inductor L1 is not reversed.

The capacitor C1, to both ends of which the power receiving circuit 21 is connected, functions as a power supply to the power receiving circuit 21. Even if a voltage across the transmission cable 3 is decreased instantaneously as a result of the occurrence of a voltage drop thereacross caused by, e.g., transmission of a return signal or the like, each power receiving circuit 21 of the communication terminals 2 can be supplied with a voltage, which is smoothed by the capacitor C1 to be stabilized.

However, if a capacitor C1 has an extremely large capacitance, a voltage across the capacitor C1 may exceed the voltage across the transmission cable 3 instantaneously when the voltage across the transmission cable 3 decreases as a result of the occurrence of a voltage drop thereacross. In this instance, the communication terminal 2 has a time period in which power supply from the transmission cable 3 to the power receiving circuit 21 is stopped because power consumption by the power receiving circuit 21 is supplied only by the capacitor C 1. As a result, a current value (amplitude) of the return signal decreases.

In short, each communication terminal 2 draws, from the transmission cable 3, a sum of an electric current I1 flowing through the power receiving circuit 21 and an electric current I2 flowing through the transmission circuit 22 when it is normal, and also draws only the electric current I2 flowing through the transmission circuit 22 during a time period in which the power supply from the transmission cable 3 to the power receiving circuit 21 is stopped. In each communication terminal 2, during the time period in which the power supply from the transmission cable 3 to the power receiving circuit 21 is stopped, a current value drawn from the transmission cable 3 is decreased by a value corresponding to the electric current I1 flowing through the power receiving circuit 21. In the destination (the transmission unit 1) of the return signal, when a current value of the return signal decreases to be below a lower limit of receiving sensitivity, a communication error may occur.

In each communication terminal 2, capacitance of its own capacitor C1 is therefore set so that a time period in which power supply from the transmission cable 3 to its own power receiving circuit 21 is stopped is prevented from occurring or the time period is shortened enough even if it occurs. For example, in each communication terminal 2, capacitance of its own capacitor C1 is set so that an electric current always flows from the transmission cable 3 to the capacitor C1 without saturation of the capacitor C1 by a balance between a charging current of the capacitor C1 and a discharging current from the capacitor C1 to the power receiving circuit 21. This instance can avoid the occurrence of a time period in which power supply from the transmission cable 3 to the power receiving circuit 21 is stopped. Alternatively, capacitance of each capacitor C1 may be set so that when a constant delay time exists as a delay between a time point when a return signal is transmitted and a time point when a receiving circuit of the transmission unit 1 starts receiving the return signal, a time period during which power supply from the transmission cable 3 to the power receiving circuit 21 is stopped is shorter than the delay time.

Thus, each communication terminal 2 can avoid the occurrence of a communication error in the destination (the transmission unit 1) of the return signal as a result of a current value of the return signal decreasing even while a voltage applied to the power receiving circuit 21 is stabilized by the capacitor C1.

Electric currents consumed by the power receiving circuits 21 of the communication terminals 2 may increase when a voltage across the transmission cable 3 decreases instantaneously as a result of the occurrence of a voltage drop thereacross caused by transmission of a return signal or the like. That is, if an input voltage from the transmission cable 3 decreases with each power receiving circuit 21 of the communication terminals 2 consuming constant power, current consumption in each power receiving circuit 21 increases in inverse proportion to the input voltage.

It results in an increase in a total current value drawn to each communication terminal 2 from the transmission cable 3 (a sum of an electric current I1 flowing through the power receiving circuit 21 and an electric current I2 flowing through the transmission circuit 22). It is therefore desirable that impedance of each transmission circuit 22 be set so that a current value of a return signal in such an increase is equal to or less than an upper limit of receiving sensitivity by the destination of the return signal (the transmission unit 1).

In the embodiment as explained above, each communication terminal 2 is provided with an intermediate circuit 23 which is connected in parallel with a transmission circuit 22 between first and second junctions P1 and P2 and includes a series circuit of an inductor L1 and a capacitor C1, where a power receiving circuit 21 is connected between both ends of the capacitor C1. Each communication terminal 2 can therefore suppress deterioration in communication quality by suppressing a decrease in impedance to a transmission signal through its own intermediate circuit 23 even while its own power receiving circuit 21 is receiving comparatively large electric power supplied from the transmission cable 3. Moreover, since the intermediate circuit 23 is connected in parallel with the transmission circuit 22, the transmission circuit 22 is connected to the transmission cable 3 without being connected through the intermediate circuit 23. A return signal transmitted from the transmission circuit 22 is therefore not attenuated by the intermediate circuit 23.

The embodiment includes first and second input terminals T1 and T2 to be connected to the transmission cable 3, and a diode bridge 24, wherein the diode bridge 24 exists between the first and second input terminals T1 and T2 and the first and second junctions P1 and P2. The inductor L1 of the intermediate circuit 23 is accordingly connected to a secondary side of the diode bridge 24. The intermediate circuit 23 can therefore suppress a decrease in impedance caused by a reverse voltage (counter electromotive force) occurring in the inductor L1 because the direction of the voltage applied across the inductor L1 is not reversed.

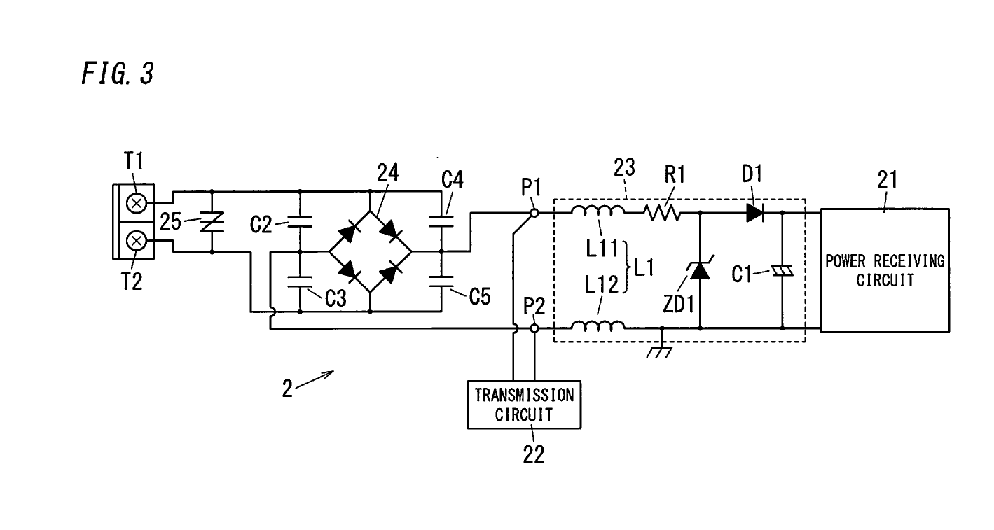

A concrete example of an intermediate circuit 23 of each communication terminal 2 according to the embodiment is hereinafter explained with reference to FIG. 3. In FIG. 3, a surge suppressor 25 is connected between first and second input terminals T1 and T2. Capacitors C2 to C5 connected in parallel with diodes constituting a diode bridge 24 are respective stray capacitance of the diodes.

In an example of FIG. 3, an inductor L1 is formed of coils L11 and L12 in series. That is, first and second coils L11 and L12 are connected in series with a capacitor C1 between the first and second junctions P1 and P2, and constitute the inductor L1 of the intermediate circuit 23. The first coil L11 is connected to the first junction P1 on a high potential side, while the second coil L12 is connected to the second junction P2 on a low potential side. The capacitor C1 is connected between the first and second coils L11 and L12. However, the first and second coils L11 and L12 are not limited to the example of FIG. 3. For example, they may exist between any one of the first and second junctions P1 and P2 and the capacitor C1. Moreover, the inductor L1 may be formed of three or more coils in series.

Thus, the intermediate circuit 23 includes the inductor L1 formed of coils, and can accordingly make individual components thereof comparatively smaller in size while having comparatively large impedance. It is consequently possible to make the components mounted on a circuit board (not shown) lower in height (a height from a surface of the circuit board).

The intermediate circuit 23 further includes a diode D1 which exists between the inductor L1(L11) and the capacitor C1 so as to prevent a discharging current of the capacitor C1 from flowing through the inductor L1(L11). In the example of FIG. 3, the diode D1 exists between the first coil L11 and the capacitor C1 with anode and cathode thereof directed at the first coil L11 side and the capacitor C1 side, respectively.

Thus, the intermediate circuit 23 has the backflow prevention diode D1 and can accordingly prevent an electric current from flowing from the capacitor C1 to the inductor L1 even if a voltage across the capacitor C1 exceeds a voltage across a transmission cable 3 instantaneously when the voltage across the transmission cable 3 decreases. The intermediate circuit 23 can therefore prevent the impedance drop caused by a reverse voltage (counter electromotive force) occurring in the inductor L1.

The intermediate circuit 23 further includes a (second) resistor R1 which exists between the inductor L1 and the capacitor C1. In the example of FIG. 3, the resistor R1 intervenes between the first coil L11 and the diode D1. The resistor R1 can suppress the occurrence of an inrush current or an overvoltage in the power receiving circuit 21 on back side when a power supply of the communication terminal 2 is turned on or the like.

The intermediate circuit 23 further includes a Zener diode ZD1 as a voltage limiting device, which is connected in parallel with the capacitor C1 and configured to limit a voltage applied across the capacitor C1. The Zener diode ZD1 is connected between both ends of the capacitor C1 through the diode D1. A maximum voltage applied across the ends of capacitor C1 is accordingly to be limited by a breakdown voltage of the Zener diode ZD1. The intermediate circuit 23 can protect the capacitor C1 from the overvoltage even if a voltage applied across the first and second input terminals T1 and T2 increases. It is also possible to comparatively decrease a withstand voltage of the capacitor C1 or a rated maximum current of the inductor L1 and thereby to make the intermediate circuit smaller in size. In the example of FIG. 3, an anode of the Zener diode ZD1 functions as a ground of the power receiving circuit 21. The voltage limiting device is not limited to the Zener diode, but may be a varistor or the like, for example.

The intermediate circuit 23 shown in FIG. 3 is just one example. It is desirable that the intermediate circuit 23 include a series circuit of the inductor L1 and the capacitor C1, which is connected in parallel with the transmission circuit 22 between the first and second junctions P1 and P2. That is, in the intermediate circuit 23, the inductor L1 may be one coil, and the diode D1, the resistor R1 and the Zener diode ZD1 may be properly removed.

The aforementioned embodiments exemplifies the transmission of a current-mode signal from a communication terminal 2 to the transmission unit 1 in synchronization with the return channel of a transmission signal, but is not limited thereto. Each communication terminal 2 may be a superposition terminal configured to communicate with a corresponding different communication terminal(s) by a superposition signal to be superposed on the transmission signal. In this case, the communication terminal (superposition terminal) 2 transmits, as the superposition signal, a current-mode signal synchronized with the transmission signal through the transmission circuit 22 (a signal transmitted by short-circuiting the transmission cable 3 through suitably low impedance).

A protocol of the communication by the superposition signal is different from that of the communication by the transmission signal. The superposition terminal(s) configured to perform communication by a superposition signal employs the transmission unit 1 as a power supply, not using the transmission signal transmitted from the transmission unit 1 for communication. That is, the superposition terminal is to communicate with a corresponding different superposition terminal(s) without help of the transmission unit 1, and shares the transmission cable 3 but does not have a function configured to communicate with a communication terminal(s) 2 and the transmission unit 1, configured to perform communication by the transmission signal. The communication by the superposition signal has a rapid transmission speed in comparison with the communication by the transmission signal, and suits data transmission for large quantity of data. For example, a communication terminal equipped with a liquid crystal display is to transmit and receive comparatively large quantity of data such as display data to and from a corresponding different communication terminal(s), and it is accordingly desirable that it be a superposition terminal configured to perform communication by the superposition signal.

1. A communication terminal, comprising:
first and second junctions;
a power receiving circuit which is connected to a transmission cable having two wires through the first and second junctions and configured to receive electric power supplied from the transmission cable;
a transmission circuit which is connected between the first and second junctions and configured to transmit a current-mode signal on the transmission cable by short-circuiting between the first and second junctions; and
an intermediate circuit which includes a series circuit of an inductor and a capacitor, the intermediate circuit being connected in parallel with the transmission circuit between the first and second junctions, the intermediate circuit also existing between the first and second junctions and the power receiving circuit, wherein
the power receiving circuit is connected between both ends of the capacitor.

2. The communication terminal of claim 1, further comprising:
first and second input terminals to be connected to the transmission cable; and
a diode bridge which exists between the first and second input terminals and the first and second junctions.

3. The communication terminal of claim 1, wherein
the intermediate circuit further comprises a diode which exists between the inductor and the capacitor so as to prevent a discharging current from the capacitor from flowing through the inductor.

4. The communication terminal of claim 1, wherein the inductor comprises a plurality of coils in series.

5. The communication terminal of claim 1, wherein the intermediate circuit further comprises a voltage limiting device which is connected in parallel with the capacitor so as to limit a voltage applied across the capacitor.

6. The communication terminal of claim 1, wherein the intermediate circuit further comprises a resistor which exists between the inductor and the capacitor.

7. A communication system, comprising:
the communication terminal of claim 1; and
a transmission unit configured to be connected to the transmission cable.

8. The communication terminal of claim 2, wherein
the intermediate circuit further comprises a diode which exists between the inductor and the capacitor so as to prevent a discharging current from the capacitor from flowing through the inductor.

9. The communication terminal of claim 2, wherein the inductor comprises a plurality of coils in series.

10. The communication terminal of claim 3, wherein the inductor comprises a plurality of coils in series.

11. The communication terminal of claim 2, wherein the intermediate circuit further comprises a voltage limiting device which is connected in parallel with the capacitor so as to limit a voltage applied across the capacitor.

12. The communication terminal of claim 3, wherein the intermediate circuit further comprises a voltage limiting device which is connected in parallel with the capacitor so as to limit a voltage applied across the capacitor.

13. The communication terminal of claim 4, wherein the intermediate circuit further comprises a voltage limiting device which is connected in parallel with the capacitor so as to limit a voltage applied across the capacitor.

14. The communication terminal of claim 2, wherein the intermediate circuit further comprises a resistor which exists between the inductor and the capacitor.

15. The communication terminal of claim 3, wherein the intermediate circuit further comprises a resistor which exists between the inductor and the capacitor.

16. The communication terminal of claim 4, wherein the intermediate circuit further comprises a resistor which exists between the inductor and the capacitor.

17. The communication terminal of claim 5, wherein the intermediate circuit further comprises a resistor which exists between the inductor and the capacitor.

18. A communication system, comprising:
the communication terminal of claim 2; and
a transmission unit configured to be connected to the transmission cable.

19. A communication system, comprising:
the communication terminal of claim 3; and
a transmission unit configured to be connected to the transmission cable.

20. A communication system, comprising:
the communication terminal of claim 4; and
a transmission unit configured to be connected to the transmission cable.
